(19) United States
(12) Patent Application Publication
(10) Pub. No.: US 2003/0145199 A1
(43) Pub. Date: Jul. 31, 2003

(54) Data pool with validity detection

(76) Inventors: Layne B. Miller, Campbell, CA (US); Robert J. Petri, Santa Clara, CA (US)

Correspondence Address: PILLSBURY WINTHROP, LLP, P.O. BOX 10500, MCLEAN, VA, 22102, US

(21) Appl. No.: 10/059,158

(22) Filed: Jan. 31, 2002

(51) Int. Cl. H04L 9/00

(52) U.S. Cl. 713/161

(57) ABSTRACT

An arrangement is provided for data pool with validity detection. To access data stored in a data pool on a server, a client sends a service request with a handle having an associated version indicator. When the server receives the service request, the server examines the validity of the handle based on the version indicator. The server provides the requested service only when the version based validity detection indicates that handle is valid.

### RESERVATION OF COPYRIGHT

This patent document contains information subject to copyright protection. The copyright owner has no objection to the facsimile reproduction by anyone of the patent document or the patent, as it appears in the U.S. Patent and Trademark Office files or records but otherwise reserves all copyright rights whatsoever.

### BACKGROUND

Aspects of the present invention relate to data transmission. Other aspects of the present invention relate to authenticated data transmission.

In the age of computers, data from a plurality of users if often stored on a centralized computer. Such data may be initially created and later accessed by the users. For example, in a communication system, agents may need to save data indicative of an internal state at a central control site and retrieve that data later from outside of the process during which the data was saved. With a plurality of remote agents, the internal state associated with each agent has to be stored in and later retrieved from a separate data storage area of the central site. Therefore, to facilitate the need to maintain data associated with different users, the central system must be able to distinguish different users as well as to maintain their data in a manner in which correct data for each user can be properly retrieved. For instance, an appropriate index may be generated between each user and the central location whenever there is a connection between the two. In this case, a user may use the handle, whenever communicating with the central control site, to indicate the location of the data that is to be accessed.

To provide individual services to different users, the central site should have the flexibility to manage the data storage. For example, reasonable mechanisms may need to be supported to enable fast and efficient data access. The central site may need to effectively find all the data storage locations for different users when all the connections with users are forced to close. When a corrupted handle is received, the central site may be required to detect it. The management for data access services may need to be scalable.

FIG. 1(a) (prior art) illustrates a mechanism that supports data access through pointers. Each client (110, . . . , 120) uses a pointer (130, . . . , 140) that establishes an index to a data area (160, . . . , 170) to access data stored at a central site (or a server 150). While this mechanism provides an effective means to index the data of each individual user, it is not possible for the server 150 to forcibly close all connections unless it is given all the pointers associated with the users. It is not possible for the server 150 to detect that a particular pointer is not valid. For example, a user may use, after a connection has been closed, a pointer associated with the closed connection to request a service. The server 150 has no way to know that the pointer is actually no longer valid.

FIG. 1(b) (prior art) illustrates a different mechanism that supports data access through pointers. Each client (110, . . . , 120) uses an array index that provides the information about the location of data in a data array (180) of a fixed size. Each array index points to an element in the data array 180. The data array 180 is allocated a priori and it is so allocated even when there is no need foe it. With this mechanism, even though it is easy for the server 150 to close all connections when such a need arises, it is still not possible for the server 150 to detect a invalid array index that corresponds to a closed connection. In addition, since the data array is pre-allocated with a fixed size, it is not scalable.

### BRIEF DESCRIPTION OF THE DRAWINGS

The present invention is further described in terms of exemplary embodiments, which will be described in detail with reference to the drawings. These embodiments are nonlimiting exemplary embodiments, in which like reference numerals represent similar parts throughout the several views of the drawings, and wherein:

FIGS. 1(a) and (b) (prior art) illustrate exemplary mechanisms in which an data area on a server can be accessed through either a pointer or an array index;

FIG. 2 depicts a framework in which a user accesses data via handle from a data pool mechanism, according to embodiments of the present invention;

FIG. 3 depicts a high level organization of a data pool, according to embodiments of the present invention;

FIG. 4 illustrates an exemplary relationship between pool meta data and a buffer pointer list, according to an embodiment of the present invention;

FIG. 5 illustrates an exemplary relationship between element meta data and its corresponding buffer, according to an embodiment of the present invention;

FIG. 6 illustrates an exemplary construct of a handle used by a client to request a service, according to an embodiment of the present invention;

FIG. 7 depicts the high level functional block diagram of a data pool mechanism that facilitates a server to provide services to a client based on a handle with a version indicator, according to embodiments of the present invention;

FIG. 8 illustrates exemplary operations that allow a client to control a data pool, according to an embodiment of the present invention;

FIG. 9 is an exemplary flowchart of a process, in which a client requests a service from a server using a handle with a version indicator, according to embodiments of the present invention;

FIG. 10 is an exemplary flowchart of a process, in which a server determines whether to provide service to a client based on the validity of a handle from the client, according to embodiments of the present invention; and

FIG. 11 is an exemplary flowchart of a process, in which a handle generation mechanism constructs a handle based on meta information, according to an embodiment of the present invention.

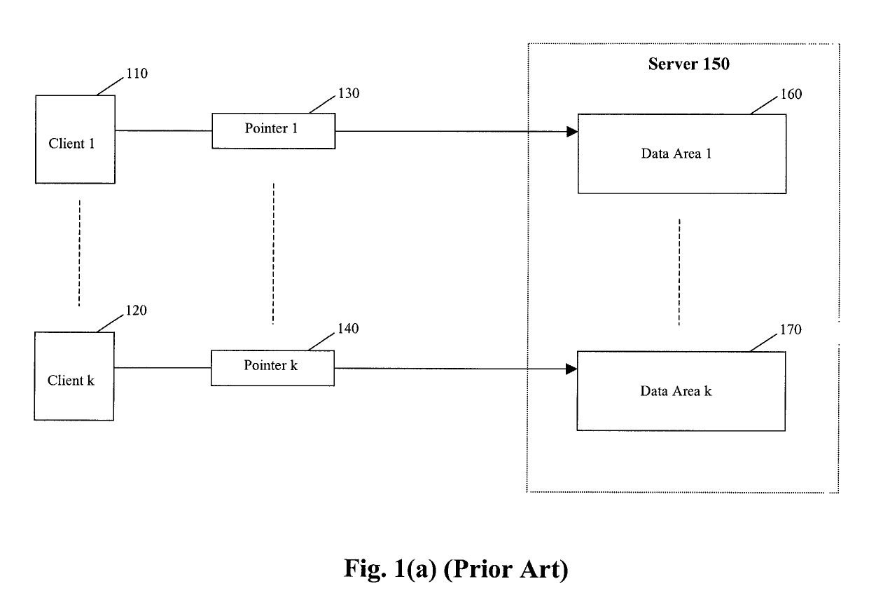

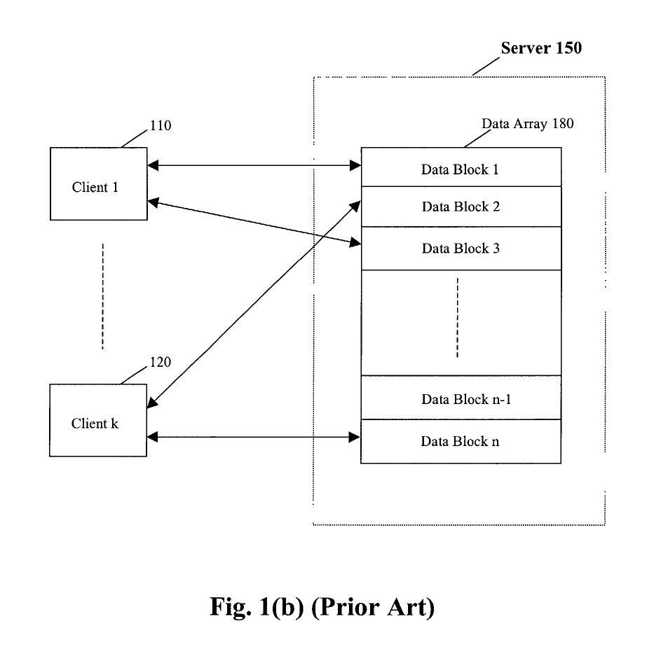

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software being run by a general-purpose computer. Any data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

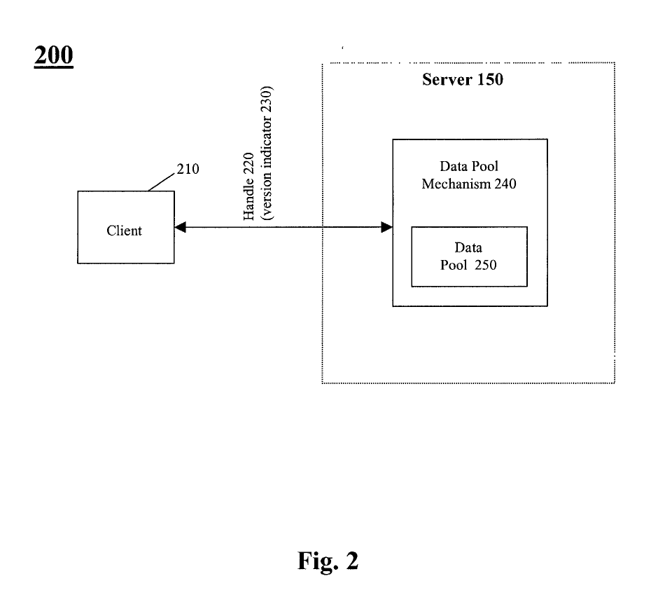

FIG. 2 depicts a framework 200 in which a client accesses data using a handle with a version indicator from a data pool managed by a data pool mechanism, according to embodiments of the present invention. The framework 200 includes a client 210 and a server 150 that provides data access services to the client 210. The server 150 includes a data pool mechanism 240 that manages a data pool 250 to facilitate data access services. The client 210 requests a data access service using a handle 220 that includes a version indicator 230 for handle validation purposes.

In FIG. 2, the server 150 refers to a data service provider that offers data access services and the client 210 refers to a data service user who requests and receives data access services. For the convenience of presentation, a data service provider is herein generically described as a server and a data service user is herein generically described as a client. Such description does not necessarily imply that a data service provider is realized on or implemented as a server, that a data service user is realized on or implemented as a client, or that the framework of the present invention is realized or implemented in a client and server environment.

The client 210, after establishing a connection with the server 150, sends a service request to the server 150 using the handle 220 that has a version indicator 230 associated with it. The handle 220 may provide an index to a data block in data pool 250 on the server 150, to which the client 210 desires to have access. Upon receiving the service request from the client 210, the server 150 passes the request to the data pool mechanism 240. The data pool mechanism 240 processes the handle 220 and verifies the validity of the handle 220 based on the version indicator 230. If the handle is valid, the data pool mechanism 240 provides the requested service.

The client 210 may communicate with the server 150 through a generic connection, such as a connection within a local area network (LAN), a wide area network (WAN), the Internet, a wireless network, or a proprietary network. Such a connection may be established in a wired fashion or in a wireless fashion. The client 210 may communicate with the server 150 via a communication device that is capable of interacting with the server 150 through the connection. Examples of a communication device include, but not limited to, a personal computer, a laptop, a hand held device such as a Palm™ Pilot, or a wireless cellular phone.

The communication between the client 210 and the server 150 may also be enabled via other means such as local interfaces. In this case, the server 150 may provide services through an interface which may be implemented as a library with well defined application programming interfaces (API) or as software development kit (SDK). Such an interface may also be made available on the world wide web (WWW) so that the client 210 may access the services from the server 150 using a browser via the Internet.

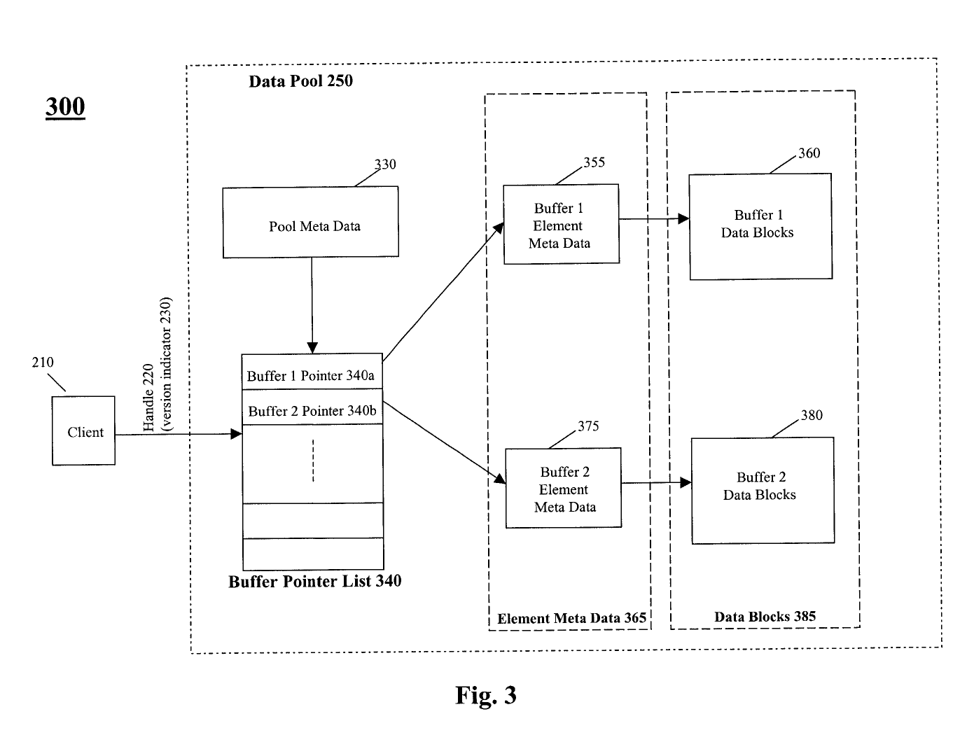

FIG. 3 depicts a high level architecture of the data pool 240 in which data blocks are managed and accessed via a hierarchy of meta data, according to embodiments of the present invention. The data pool 250 comprises a hierarchy of meta data structures that support efficient management of a plurality of data blocks 385 organized as a set of buffers, providing storage space for data. In FIG. 3, two buffers are illustrated, buffer 1 360 and buffer 2 380. Each buffer may further include a plurality of data blocks called element data blocks, each of which may be properly indexed through element meta data that is associated with the buffer. For example, buffer 1 data blocks 360 may be appropriately indexed through buffer 1 element meta data 355 and buffer 2 data blocks 380 may be appropriately indexed by buffer 2 element meta data 375. Different pieces of element meta data associated with individual buffers may be collectively called element meta data (365 in FIG. 3). Similarly, individual buffers may be collectively called data blocks (385 in FIG. 3).

To properly index individual element data blocks within each buffer, the server 150 maintains a hierarchy of meta data, including pool meta data 330, a buffer pointer list 340, and element meta data 365. The pool meta data 330 may provide high level information about the structure of the hierarchy and the data block organization. For example, it may specify the total number of buffers that are currently available and the number of data blocks within each buffer. It may also store the information about maximum number of buffers that the underlying data pool may ultimately support. The buffer pointer list 340 comprises a set of buffer pointers, each of which indexes to an element meta data associated with a buffer that has been allocated in the server 150. The pool meta data 330 may relate to the buffer pointer list 340. For example, the total number of allocated buffers specified in the pool meta data 330 may explicitly indicate how many buffer pointers exist in the buffer pointer list 340.

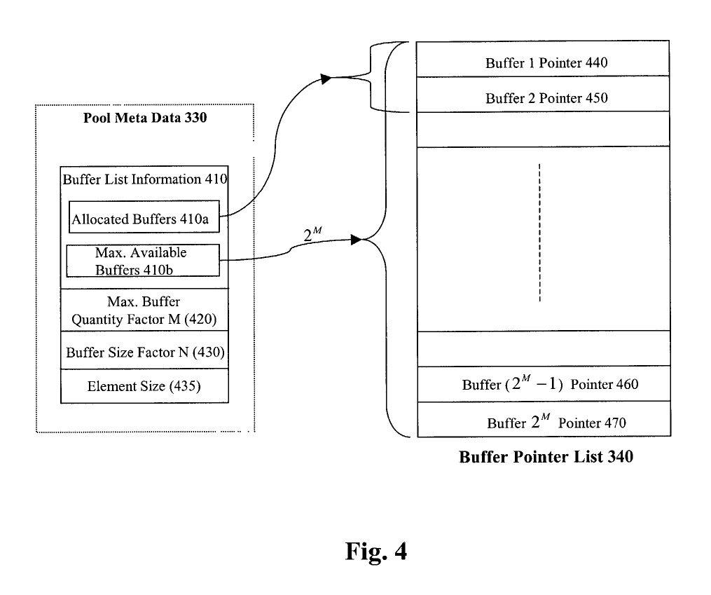

The relationship between the two is illustrated in FIG. 4. The pool meta data 330 includes buffer list information 410, a total buffer quantity factor M 420, a buffer size factor N 430, and an element size 435. The total buffer quantity factor 420 corresponds to an integer M, which may be used to determine the maximum number of buffers that the underlying data pool ultimately supports. For example, the maximum number of buffers facilitated by the server 150 may be determined as 2^{M}. The buffer size factor 430 corresponds to an integer N, which may be used to determine the number of element data blocks in each buffer as 2^{N}. In addition, the element size 435 may correspond to an integer describing the size of each element data block. For example, the element size 435 may be 512 meaning that each element data block consists of 512 bytes.

The buffer list information 410 provides information about buffers. It includes allocated buffers 410a, which indicates the number of buffers that have been allocated in the server 150 and maximum number of buffers 410b that the server 150 can allocate. As discussed above, this may be determined as 2^{M}. In FIG. 4, the buffer pointer list 340 may accordingly allocated so that it may host a maximum of 2^{M} pointers. There may be fewer than the maximum available buffers that are currently allocated by the server 150. For example, in the illustrative embodiment depicted in FIG. 4, there are only two buffers that are currently allocated. In this case, the information of the allocated buffers 410a corresponds to 2, indicating that only the first two entries in the buffer pointer list 340 contain valid pointers to corresponding meta data of the allocated buffers.

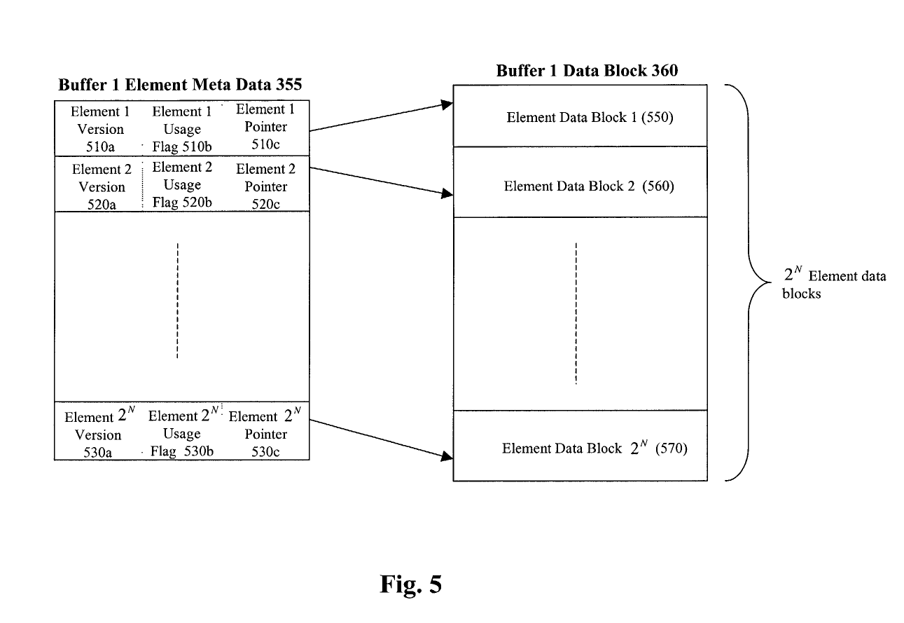

FIG. 5 illustrates an exemplary relationship between the element meta data 365 associated with buffer 1 360 and individual element data blocks in the buffer, according to an embodiment of the present invention. In FIG. 5, buffer 1 data block 360 includes a plurality of k element data blocks, element data block 1 550, element data block 2 560, . . . , element data block 2^{N} 570. The number of element data blocks in a buffer (i.e., 2^{N}) is determined according to the buffer size factor 430 specified in the pool meta data 330. To properly index each of the element data blocks in buffer 1 360, the associated buffer 1 element meta data 340a comprises a plurality of corresponding 2^{N} entries, each of which associates with an element data block in the buffer 1 360 and includes a version number, a usage flag, and a pointer. For example, for the element data block 1 550, there is a corresponding entry in the buffer 1 element meta data 340a that contains an element 1 version 510a, an element 1 usage flag 510b, and an element 1 pointer 510c that directly indexes to the location of the element data block 1 550.

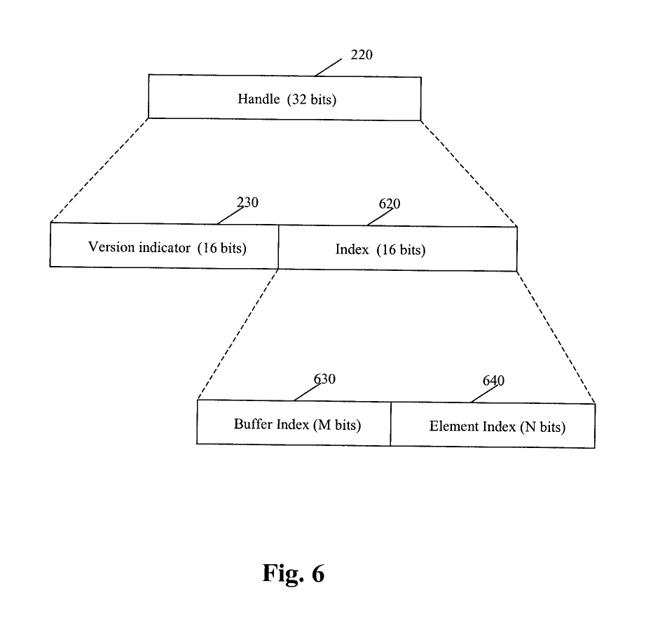

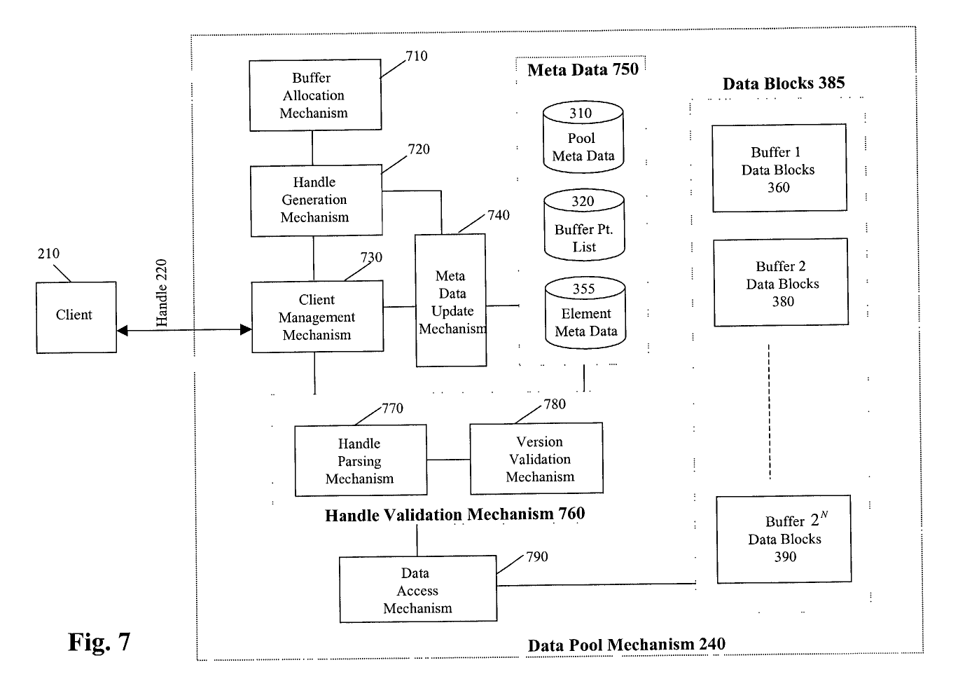

The element 1 version 510a indicates the current version of the underlying element data block 1 550. Such a version number for each element data block may be used for checking the validity of a service request handle from the client 210 (this will be discussed in reference to FIG. 6 and FIG. 7). The element usage flag 510b specifies whether the element 1 data block is currently in use. The element 1 pointer 510c may correspond to a memory address where the element 1 data block is located. As shown in FIG. 5, each of the element data block in a buffer has a corresponding entry in its associated element meta data, through which the element data block is accessed. In addition, each buffer is associated with its element meta data that provides indices to all the data blocks in that buffer.

The client 210 may send a request to the server 150 for a service to, for example, store data into the server 150 or access data that is already stored in the server 150. The handle 220, which is sent along with the service request, may contain information necessary for the server 150 to provide the desired service. For instance, the handle may indicate the location where the data the client wishes to access resides. For example, if the client 210 desires to retrieve some data that is already stored in the server 150, the handle may provide an index pointing to the memory location where the desired data is currently stored.

FIG. 6 illustrates an exemplary construct of the handle 220, according to an embodiment of the present invention. The exemplary construct illustrated in FIG. 6 corresponds to a 32 bits data string, in which the first 16 bits may be used to store the version indicator 230 and the remaining 16 bits may be used to provide an index pointing to the location where the desired data access being requested. The 16 bit index may further include a buffer index 630 of M bits and an element index 640 of N bits, where M+N=16. As described in FIG. 4 and FIG. 5, there are a maximum of 2^{M} buffers and each buffer includes 2^{N} element data blocks. Therefore, the M-bit buffer index 630 is capable of indexing the full range of maximum number of buffers that the underlying data pool may ultimately support. Similarly, the N-bit element index 640 is capable of indexing the full range of element data blocks in any buffer.

The handle 220 may be constructed using a string with a reasonable number of bits, which may be determined according to application needs. The string may be made small enough so that it can be manipulated easily. It may also need to be large enough so that it has the capability of indexing a reasonable range of memory blocks on the server 150. The final number of bits used to construct the handle 220 may be determined by balancing the factors mentioned.

The version indicator 230 may be generated, when the handle 220 is created, based on the version number of the element data block that is indexed by the handle 220. That is, if a handle contains an index to the element data block 1 550 in the buffer 1 360 (see FIG. 5), the element 1 version 510a can be used as the version indicator 230 to construct the handle. Therefore, in normal situations, the version indicator 230 in a handle and the element version number of the underlying element data block corresponding to the handle should be consistent with each other. The server 150 verifies the validity of a handle based on such consistency.

FIG. 7 depicts the high level functional block diagram of the data pool mechanism 240 that facilitates the server 150 to provide services to the client 210, according to embodiments of the present invention. As described earlier, the data pool 250 within the data pool mechanism 240 includes a plurality of data blocks 385 and a hierarchy of meta data 750. The data blocks 385 are organized into a set of buffers, each of which comprises a plurality of element data blocks. The meta data 750 comprises the pool meta data 310, the buffer pointer list 320, and the element mea data 355. To facilitate data access, the data pool mechanism 240 further comprises a buffer allocation mechanism 710, a handle generation mechanism 720, a client management mechanism 730, a meta data update mechanism 740, a handle validation mechanism 760, and a data access mechanism 790.

The handle generation mechanism 720 is responsible for creating a handle for a connection between a client and the server 150. Upon the establishment of a connection, the client management mechanism 730 may invoke the handle generation mechanism 720 to construct a handle for the connection. During creating a handle, the handle generation mechanism 720 may identify an available element data block in a currently allocated buffer and then retrieve related meta information associated with the identified element data block (e.g., a buffer index, an element data block index, as well as a version number of the identified element data block) and uses such information in constructing the handle.

If the handle generation mechanism 710 fails to identify an available element data block in any of the currently allocated buffers, it may invoke the buffer allocation mechanism 710 to allocate a new buffer prior to constructing the handle. Upon the completion of allocating a new buffer, the handle generation mechanism 720 may invoke the meta data update mechanism 740 to create the meta information relevant to the new buffer and incorporate such meta information into the meta data hierarchy. Based on the newly updated meta information, the handle generation mechanism 720 constructs a handle accordingly.

The handle generated by the handle generation mechanism 720 is sent, via the client management mechanism 730, to the client. If the client subsequently uses the handle to request a service from the server 150, the client management mechanism 730 intercepts the service request and invokes the handle validation mechanism 760 to check the validity of the handle before the requested service can be provided. The handle validation mechanism 760 includes a handle parsing mechanism 770 and a version validation mechanism 780. The client management mechanism 730 may pass the handle received from a requesting client to the handle parsing mechanism 770, which extracts information that is necessary to perform validity check. For example, a version indicator in the handle can be extracted so that a version based validation can be carried out.

Furthermore, to determine the consistency between the version indicator in a handle and the version number of the element data block indexed by the handle, the handle parsing mechanism 770 may extract the buffer index and the element data block index from the handle and then use such indices to retrieve the version number from the meta data 750. Both the version indicator from the handle and the version number from the meta data 750 may then be sent to the version validation mechanism 780 to determine whether they are consistent.

The version validation mechanism 780 may perform the validation task in a fashion that is required by the underlying application. For example, an application may require that the version indicator and the version number be identical. A different application may require that the two are similar enough. The specific validation criterion may be realized according to application needs. Once the version validation mechanism 780 verifies the validity of the handle, it may invoke the data access mechanism 790 to carry out the requested service. If the validation fails, the version validation mechanism 780 may inform the client management mechanism 730, which may subsequently denies the requested service.

The handle 220 is generated and used during a connection session between the client 210 and the server 150. During such a session, the client may use the handle to request a service. Upon the closing of the connection, the handle may be revoked. In this case, the client management mechanism 730 invokes, upon the closing of the connection, the meta data update mechanism 740 to update meta data such as the version number and the usage flag associated with the element data block indexed by the handle generated for the connection. For example, to invalidate a handle, the usage flag can be set to “not in use” to indicate that the underlying element data block is not used. On the other hand, the corresponding version number may also be reset to a new number to replace the previously assigned version number. This ensures that if a handle associated with a closed connection is later used again for requesting a service, the service will not be granted because the version-based validation will not succeed.

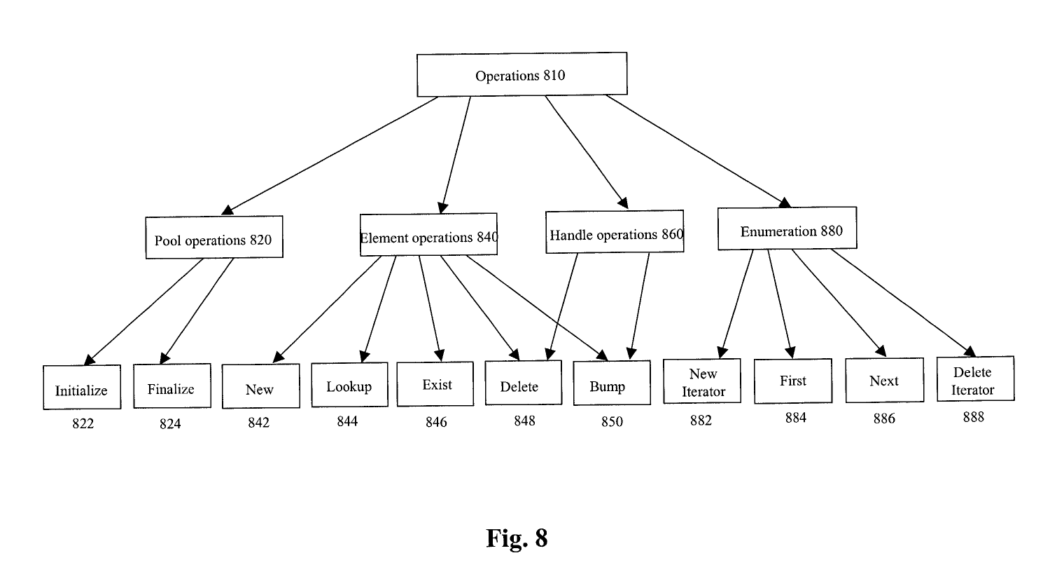

The data pool mechanism 240 may also provide the means for a client to control the data pool 250. The data pool mechanism 240 may support a set of operations that allow a client to, for example, create or manipulate the data pool 250. FIG. 8 illustrated a set of exemplary functions that the data pool mechanism 240 supports. Allowed operations 810 may include, but not limited to, pool operations 820, element operations 840, handle operations 860, and enumeration related operations 880. The pool operations 820 may involve any operation through which the client 210 may control the pool meta data. For instance, through “initialize” operation 822, the client 210 can initialize a new pool. When this operation is invoked, the client 210 may provide operation parameters such as the total buffer quantity factor 420 and the buffer size factor 430. Such parameters are used to create a pool with desired size. “Finalize” operation 824 allows the client 210 to clean up all resources and return memories to the server 150.

The element operations 840 allow the client 210 to control and to query element data blocks in a data pool. For instance, “New” operation 842 allows a client to allocate a new element within a data pool. The usage flag of such allocated element data block may be marked as “in use”. “Lookup” operation 844 permits a client to obtain the data stored in an element data block using a handle. “Exist” operation 846 may allow a client to merely query about the validity of a handle. “Delete” operation 848 permits a client to delete an element data block after use. In this case, the corresponding handle may be recycled and the meta data of the element data block (e.g., version number and usage flag) may be accordingly updated. “Bump” operation 850 provides a means for a client to update the version number of an element data block. Since a handle indexes to an element data block, operations performed on a handle may usually has an effect on the underlying element data block.

The “enumeration” operations 880 refer to the capability to enumerate the elements within a data pool. Different operations may be supported to allow a client to control the enumeration. For example, a client may perform a “new iterator” operation 882 to create an iterator that is capable of traversing the pool looking for previously allocated elements. The created iterator may report all allocated elements in some order. A client may also perform specific operations to control the sequence by which the elements in a data pool are enumerated. For example, “First” operation 884 may be performed to jump to the first allocated element and return its relevant meta data (e.g., usage flag and version number). Similarly, “Next” operation 886 allows a client to move to the next element from current position. Operation “delete iterator” 888 allows a client to stop an on-going iteration and free the resources.

Through the pool data mechanism 240, the server 150 may easily identify, all the element data blocks that are currently used for connections with clients. For example, the server 150 may recognize such data blocks by simply examining the meta data 750. If a need of closing all connections arises, the server 150 may easily reset the meta data into proper status (e.g., change all element usage flags from “in use” to “not in use” or update the version numbers) and then safely close all connections. The meta data 750 provides efficient indexing mechanism to the data blocks 385. In addition, buffers may be allocated on demand. That is, it is not necessary to allocate maximum number of buffers prior to their use. This allows a more economical use of space. Furthermore, as the handle 220 is of a fixed length, it can be easily marshaled through networks, when necessary, between the server 150 and clients at different locations.

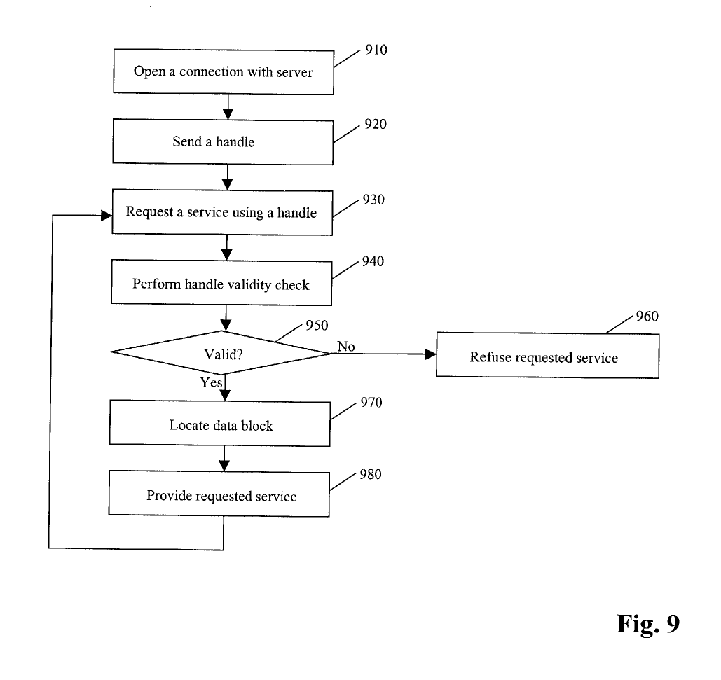

FIG. 9 is an exemplary flowchart of a process, in which a client (e.g., 210) requests a service from the server 150 via a connection and a handle with a version indicator, according to embodiments of the present invention. The client 210 first opens, at 910, a connection with the server 150. Upon the opening of the connection, the server 150 constructs a handle with the version indicator 230, for the connection and sends, at 920, the handle to the client 210. The client 210 then uses the handle to request, at 930, a service from the server 150.

When the server 150 receives the service request (with a handle having a version indicator), it performs, at 940, validity check on the handle. If the handle is invalid, determined at 950, the server 150 refuses, at 960, the requested service. Otherwise, the server 150 locates, at 970, the element data blocks indicated by the handle and provides, at 980, the requested service.

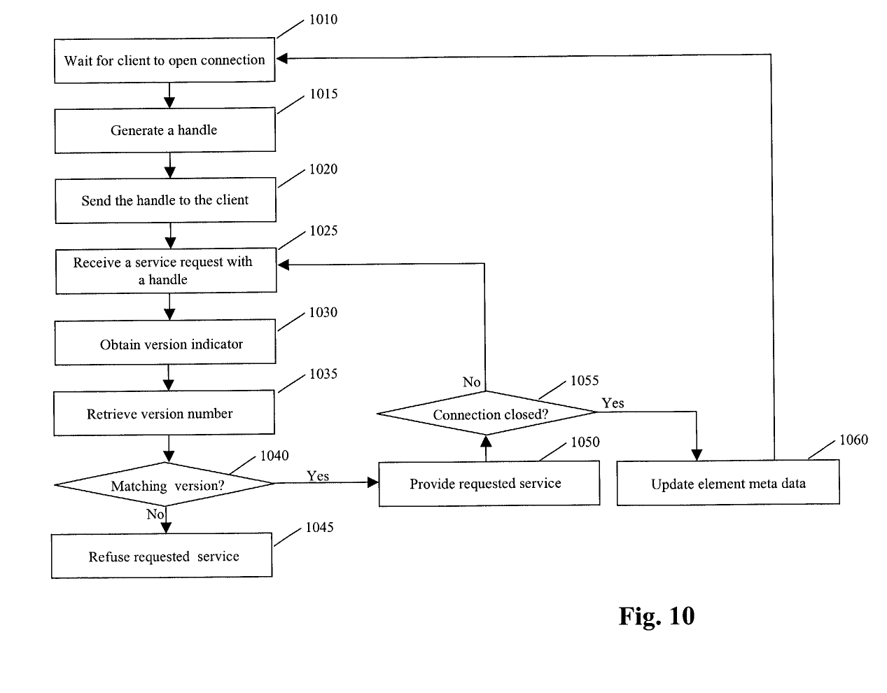

FIG. 10 is an exemplary flowchart of a process for the server 150, according to embodiments of the present invention. The server 150 first waits, at 1010, for a client to open a connection. Upon the establishment of a connection with a client (e.g., 210), the server 150 generates, at 1015, a handle for the connection with a version indicator and then sends, at 1020, the handle to the client 210. When a service request (with the handle with a version indicator) is received at 1025, the server 150 extracts, at 1030, the version indicator from the handle and retrieves, at 1035, the version number of the underlying element data block indexed in the handle.

If the version indicator does not match the version number, determined at 1040, the server 150 denies, at 1045, the requested service. If the two version numbers match, the server 150 provides, at 1050, the requested service to the client 210. When the connection between the client 210 and the server 150 is closed, determined at 1055, the server 150 updates, at 1060, the meta data associated with the element data block indexed by the handle. Then the server 150 continues to wait for connections. If the current connection is not closed, determined at 1055, the server 150 continues to wait for the next service request from the client 210.

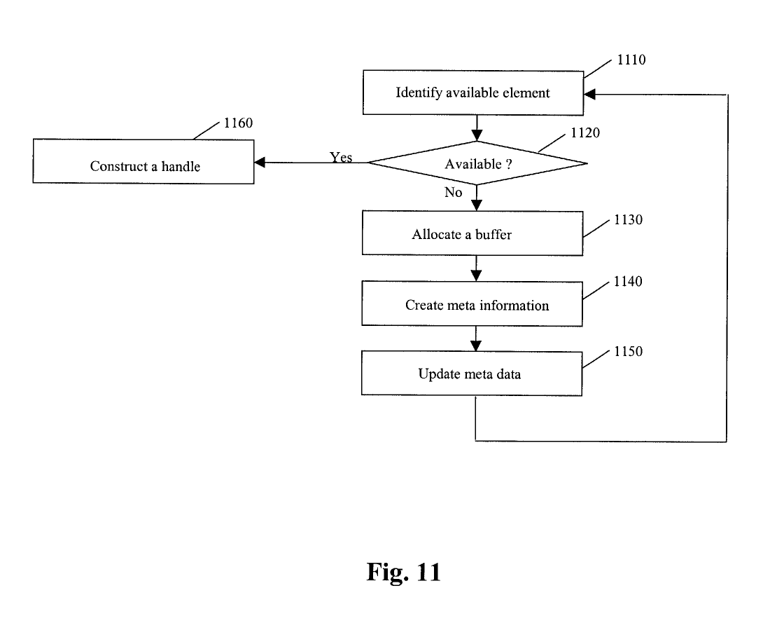

FIG. 11 is an exemplary flowchart of a process, in which the handle generation mechanism 720 of the server 150 constructs a handle based on meta information, according to an embodiment of the present invention. The handle generation mechanism 720 first identifies, at 1110, an available element data block from currently allocated buffers. If no available element data block can be identified, determined at 1120, the handle generation mechanism 720 invokes the buffer allocation mechanism 710 to allocate, at 1130, a new buffer. Upon the allocation of a new buffer, new meta information associated with the new buffer is created at 1140. This includes the index to the meta data associated with the new buffer as well as all the entries of an element meta data corresponding to the new buffer. Based on the created meta information, the meta data hierarchy is accordingly updated at 1150. This includes updating the allocated buffer information 410a in the pool meta data 330, incorporating the new buffer pointer to the buffer pointer list 340, and initializing the version number, the usage flag, and element pointer in each and every entry of the element meta data of the new buffer. The handle generation mechanism 720 then returns to the identification of an available element data block from an allocated buffer. Once an available element data block is identified, a handle is constructed, at 1160, based on relevant meta information associated with the identified available element data block.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
receiving a handle associated with a version indicator sent from the server to the client;
requesting a service from the server using the handle;
examining the validity of the handle based on the version indicator; and
providing, if the handle is valid, the requested service.

2. The method according to claim 1, wherein the handle includes:
a version number to serve as the version indicator of the handle; and
an index that points to an element data block of an allocated buffer in a data pool within the server.

3. The method acording to claim 2, wherein the index comprises:
a buffer index that points to the allocated buffer in the data pool; and
an element index that points to an entry in element meta data for the allocated buffer, the entry corresponding to the element data block in the allocated buffer and containing information describing the status of the element data block.

4. The method according to claim 3, further comprising, prior to said receiving the handle:
generating pool meta data that describes the data pool;
generating a buffer pointer list containing at least one buffer index, each of which pointing to a corresponding buffer in data pool; and
generating element meta data for each corresponding buffer, containing a plurality of entries, each of which associates with an element data block in the corresponding buffer and includes a version number, indicating the version of the element data block, a usage flag, indicating whether the element data block is currently in use, as well as an element pointer that specifies the location of the element data block in the corresponding buffer.

5. The method according to claim 4, wherein the pool meta includes at least some of:
a quantity factor which determines a total number of buffers that can be allocated on the server;
a buffer size factor which determines the number of element data blocks in a buffer; and
an allocated buffer factor that indicates a total number of currently allocated buffers on the server.

6. A method for a server, comprising:
waiting for a client to open a connection;
generating a handle with a version indicator for the connection;
sending the handle to the client;
receiving a service request from the client using the handle for a service;
verifying the validity of the handle based on the version indicator; and
providing, if the handle is valid, the requested service.

7. The method according to claim 6, further comprising, prior to said generating:
generating pool meta data describing the organization of a data pool;
generating a buffer pointer list containing at least one buffer index, each of the buffer index pointing to a corresponding buffer in the data pool; and
generating element meta data for each corresponding buffer, containing a plurality of entries, each of which associates with an element data block in the corresponding buffer and includes a version number, indcating the version of the element data block, a usage flag, indicating whether the element data block is currently in use, as well as an element pointer that specifies the location of the element data block in the corresponding buffer.

8. The method according to claim 7, wherein the pool meta includes at least some of:
a quantity factor which determines a total number of buffers that can be allocated on the server;
a buffer size factor which determines the number of element data blocks in a buffer; and
an allocated buffer factor that indicates a total number of currently allocated buffers on the server.

9. The method according to claim 8, wherein the handle comprises:
a version number to serve as a version indicator of the handle; and
a buffer index that points to a buffer that has been allocated in the server; and
an element index that points to an entry in element meta data for the buffer, the entry corresponding to an element data block in the buffer and containing a version number indicating the version of the element data block.

10. The method according to claim 9, wherein said generating a handle comprises:
identifying an available element data block in an allocated buffer;
obtaining a version number and an element index of the available element data block from the element meta data of the allocated buffer, and a buffer index of the allocated buffer from the buffer pointer list; and
constructing the handle based on the version number, the element index, and the buffer index.

11. The method according to claim 10, further comprising:
allocating, if the available element data block can not be identified from any buffer that has been allocated, a new buffer with a number of element data blocks determined according to the buffer size factor;
creating element meta data for the new buffer;
initializing the element meta data created for the new buffer;
updating the buffer pointer list to include a buffer index pointing to the new buffer; and
selecting, prior to said obtaining, an element data block from the new buffer as the available element data block.

12. The method according to claim 11, wherein said verifying the validity of the handle compries:
extracting the version indicator contained in the handle;
retrieving a version number from an entry of the element meta data, indexed by the element index in the handle and representing the version of a corresponding element data block, the element meta data associating with a buffer that is indexed by the buffer index in the handle;
determining whether the version indicator from the handle is consistent with the version number of the element data block of the buffer represented by the handle.

13. The method according to claim 12, further comprising:
updating, when the connection is closed, the version number of the element data block in the element meta data.

14. A system, comprising:
a data pool mechanism residing on a server for providing services based on the validity of a service request; and
a client connecting to the server for obtaining a service from the server by sending a service request to the server using a handle, generated by the server with a version indicator, the service being obtained if the handle is valid determined based on the version indicator.

15. The system according to claim 14, wherein the data pool mechanism comprises:
a plurality of data blocks for storing data that is accessible to the client when the handle is valid;
meta data for providing description and indices of the data blocks, the desscription including a version number for each of the data blocks;
a handle validation mechanism for validating the handle received from the client with the service request based on the version indicator and the version number of an element data block indexed by the handle; and
a data access mechanism for accessing the data blocks if the handle is valid.

16. The system according to claim 15, further comprising:
a handle generation mechanism for constructing a handle based on the meta data; and
a meta data update mechanism for updating the meta data.

17. A system for a data pool mechanism, comprising:
a client management mechanism for processing a service request sent from a client using a handle with a version indicator;
a plurality of data blocks for storing data that is accessible to the client;
meta data for providing description and indices of the data blocks, the desscription including a version number for each of the data blocks;
a handle validation mechanism for validating the handle received from the client with the service request based on the version indicator and the version number of an element data block indexed by the handle; and
a data access mechanism for accessing the data blocks if the handle is valid.

18. The system according to claim 17, wherein the plurality of data blocks are organized into a set of allocated buffers, each of which includes a plurality of element data blocks.

19. The system according to claim 18, wherein the meta data includes at least some of:
pool meta data for describing the organization of the plurality of data blocks;
a buffer pointer list; and
element meta data.

20. The system according to claim 19, wherein the handle validation mechanism includes:
a handle parsing mechanism for parsing the handle; and
a handle verification mechanism for verifying that the version indicator extracted from the handle is consistent with the version number of the element data block to which the handle indexes.

21. The system according to claim 20, further comprising:
a buffer allocation mechanism for allocating a new buffer, when there is no available element data block in the allocated buffers, to generate a new allocated buffer;
a meta data update mechanism for udating the meta data, either when a new allocated buffer is generated or when the connection with the client is closed to generate updated meta data; and
a handle generation mechanism for constructing a handle based on the updated meta data.

22. A machine-accessible medium encoded with data, the data, when accessed, causing:
receiving a handle associated with a version indicator sent from the server to the client;
requesting a service from the server using the handle;
examining the validity of the handle based on the version indicator; and
providing, if the handle is valid, the requested service.

23. The medium according to claim 22, the data, when accessed, further causing, prior to said receiving the handle:
generating pool meta data that describes the data pool;
generating a buffer pointer list containing at least one buffer index, each of which pointing to a corresponding buffer in data pool; and
generating element meta data for each corresponding buffer, containing a plurality of entries, each of which associates with an element data block in the corresponding buffer and includes a version number, indicating the version of the element data block, a usage flag, indicating whether the element data block is currently in use, as well as an element pointer that specifies the location of the element data block in the corresponding buffer.

24. A machine-accessible medium encoded with data, the data, when accessed, causing:
waiting for a client to open a connection;
generating a handle with a version indicator for the connection;
sending the handle to the client;
receiving a service request from the client using the handle for a service;
verifying the validity of the handle based on the version indicator; and
providing, if the handle is valid, the requested service.

25. The medium according to claim 24, the data, when accessed, further causing, prior to said generating:
generating pool meta data describing the organization of a data pool;
generating a buffer pointer list containing at least one buffer index, each of the buffer index pointing to a corresponding buffer in the data pool; and
generating element meta data for each corresponding buffer, containing a plurality of entries, each of which associates with an element data block in the corresponding buffer and includes a version number, indcating the version of the element data block, a usage flag, indicating whether the element data block is currently in use, as well as an element pointer that specifies the location of the element data block in the corresponding buffer.

26. The medium according to claim 24, wherein said generating a handle comprises:
identifying an available element data block in an allocated buffer;
obtaining a version number and an element index of the available element data block from the element meta data of the allocated buffer, and a buffer index of the allocated buffer from the buffer pointer list; and
constructing the handle based on the version number, the element index, and the buffer index.

27. The medium according to claim 26, the code, when accessed, further causing:
allocating, if the available element data block can not be identified from any buffer that has been allocated, a new buffer with a number of element data blocks determined according to the buffer size factor;
creating element meta data for the new buffer;
initializing the element meta data created for the new buffer;
updating the buffer pointer list to include a buffer index pointing to the new buffer; and
selecting, prior to said obtaining, an element data block from the new buffer as the available element data block.

28. The medium according to claim 27, wherein said verifying the validity of the handle compries:
extracting the version indicator contained in the handle;
retrieving a version number from an entry of the element meta data, indexed by the element index in the handle and representing the version of a corresponding element data block, the element meta data associating with a buffer that is indexed by the buffer index in the handle;
determining whether the version indicator from the handle is consistent with the version number of the element data block of the buffer represented by the handle.

29. The medium according to claim 28, the data, when accessed, further causing:
updating, when the connection is closed, the version number of the element data block in the element meta data.
